(19) United States
(12) Patent Application Publication
(10) Pub. No.: US 2020/0339792 A1
(43) Pub. Date: Oct. 29, 2020

(54) THERMOPLASTIC ELASTOMER

(71) Applicant: VIBO ENTERPRISE (HUIZHOU) CO., LTD., Huizhou (CN)

(72) Inventors: Fung Fung Becky NG, HONG KONG (HK); Xiaoxia KUANG, SHENZHEN (CN)

(73) Assignee: VIBO ENTERPRISE (HUIZHOU) CO., LTD.

(21) Appl. No.: 16/409,816

(22) Filed: May 11, 2019

(30) Foreign Application Priority Data
Apr. 26, 2019 (CN) 201910345080.7

(51) Int. Cl. C08L 23/08; C08L 25/06; C08K 5/01

(52) U.S. Cl. CPC C08L 23/0838; C08L 2207/04; C08K 5/01; C08L 25/06

(57) ABSTRACT

A thermoplastic elastomer includes the following raw materials by mass ratios: 26-33% of SEBS, 65-72% of white mineral oil, 1.5-2.5% of oily expandable polystyrene and 0.008-0.15% of anti-bacterial agent. The thermoplastic elastomer is prepared by the following steps: S1: acquiring SEBS and the oily expandable polystyrene; S2: mixing the raw materials evenly to obtain mixture A; and S3: performing high temperature sterilization treatment on the mixture A to prepare a finished product, wherein S to S3 are processed in an aseptic workshop. In the present invention, the prepared finished elastomer product is environmentally friendly, non-toxic and harmless, and has strong operability. The elastomer has DIY function and can be made into various shapes through various molds. The finished elastomer product is light in weight, soft and smooth, provides a soft feel, and can be used repeatedly. The finished elastomer product has good playability and fun. When the elastomer falls on the ground and is broken, the elastomer has a good dispersion effect on the ground due to good elasticity, and is very aesthetic.

### TECHNICAL FIELD

The present invention relates to the field of bouncing and rolling rubber toys of children, and particularly relates to a thermoplastic elastomer.

### BACKGROUND OF THE PRESENT INVENTION

Toys are non-artificial things such as sand, stone, mud and branches, and can also be artificial things. The toys shall be understood in a broad sense, and are not limited to the things sold on the street for playing. Anything that can be played, seen, heard and touched can be called a toy.

Space sand is one of the artificial toys. However, the existing space sand toys are made of fine sand and silicone oil, and have potential safety hazards in use. The space sand is inelastic and heavy. In use, the space sand can only be shaped by toy molds, and may become less interesting after a long time.

### SUMMARY OF PRESENT INVENTION

### (I) Purpose

To solve the technical problems in the background, the present invention proposes a thermoplastic elastomer which can be made into various shapes through various molds. The finished elastomer product is light in weight, soft and smooth, provides a soft feel, and can be used repeatedly. The finished elastomer product has good playability and fun.

### (II) Technical Solution

To solve the above problems, the present invention provides a thermoplastic elastomer, comprising the following raw materials by mass ratios: 26-33% of SEBS, 65-72% of white mineral oil, 1.5-2.5% of oily expandable polystyrene and 0.008-0.15% of anti-bacterial agent.

The thermoplastic elastomer is prepared by the following steps:

S1: acquiring SEBS and the oily expandable polystyrene;

S2: mixing the raw materials evenly to obtain mixture A; and

S3: performing high temperature sterilization treatment on the mixture A to prepare a finished product,

wherein S1 to S3 are processed in an aseptic workshop.

Preferably, the raw materials by the mass ratios comprise: 72% of white mineral oil, 1.5% of oily expandable polystyrene, 0.008% of anti-bacterial agent and the balance of SEBS.

Preferably, the raw materials by the mass ratios comprise: 33% of SEBS, 1.5% of oily expandable polystyrene, 0.008% of anti-bacterial agent and the balance of white mineral oil.

Preferably, the raw materials by the mass ratios comprise: 65% of white mineral oil, 2.5% of oily expandable polystyrene, 0.15% of anti-bacterial agent and the balance of SEBS.

Preferably, the raw materials by the mass ratios comprise: 26% of SEBS, 2.5% of oily expandable polystyrene, 0.15% of anti-bacterial agent and the balance of white mineral oil.

Preferably, the raw materials by the mass ratios comprise: 30% of SEBS, 67.9% of white mineral oil, 2% of oily expandable polystyrene and 0.1% of anti-bacterial agent.

Preferably, SEBS and the oily expandable polystyrene are granular or powdery.

Preferably, the finished product is subjected to ASTM, EN71, USP61, USP62 and USP51 bacterial culture tests; if the product is sterile, the finished product is qualified and is vacuum-packed; and if the product has bacteria, the finished product is unqualified and is subjected to the high temperature sterilization again.

The above technical solution of the present invention has the following beneficial technical effects: the prepared finished elastomer product is environmentally friendly, non-toxic and harmless, and has strong operability. The elastomer has DIY function and can be made into various shapes through various molds. The finished elastomer product is light in weight, soft and smooth, provides a soft feel, and can be used repeatedly. The finished elastomer product has good playability and fun. When the elastomer falls on the ground and is broken, the elastomer has a good dispersion effect on the ground due to good elasticity, and is very aesthetic.

### DETAILED DESCRIPTION OF PREFERRED EMBODIMENTS

In order to make the purpose, the technical solution and advantages of the present invention clearer, the present invention will be further described in detail below in combination with specific embodiments. It should be understood that the descriptions are only exemplary, and are not intended to limit the scope of the present invention. Furthermore, in the following illustration, descriptions of well-known structures and technologies are omitted to avoid unnecessarily obscuring the concepts of the present invention.

A thermoplastic elastomer proposed by the present invention comprises the following raw materials by mass ratios: 26-33% of SEBS, 65-72% of white mineral oil, 1.5-2.5% of oily expandable polystyrene and 0.008-0.15% of anti-bacterial agent.

The thermoplastic elastomer is prepared by the following steps:

S1: acquiring SEBS and the oily expandable polystyrene;

S2: mixing the raw materials evenly to obtain mixture A; and

S3: performing high temperature sterilization treatment on the mixture A to prepare a finished product,

wherein S1 to S3 are processed in an aseptic workshop.

In an optional embodiment, the raw materials by the mass ratios comprise: 72% of white mineral oil, 1.5% of oily expandable polystyrene, 0.008% of anti-bacterial agent and the balance of SEBS.

In an optional embodiment, the raw materials by the mass ratios comprise: 33% of SEBS, 1.5% of oily expandable polystyrene, 0.008% of anti-bacterial agent and the balance of white mineral oil.

In an optional embodiment, the raw materials by the mass ratios comprise: 65% of white mineral oil, 2.5% of oily expandable polystyrene, 0.15% of anti-bacterial agent and the balance of SEBS.

In an optional embodiment, the raw materials by the mass ratios comprise: 26% of SEBS, 2.5% of oily expandable polystyrene, 0.15% of anti-bacterial agent and the balance of white mineral oil.

In an optional embodiment, the raw materials by the mass ratios comprise: 30% of SEBS, 67.9% of white mineral oil, 2% of oily expandable polystyrene and 0.1% of anti-bacterial agent.

In the present invention, the prepared finished elastomer product is environmentally friendly, non-toxic and harmless, and has strong operability. The elastomer has DIY function and can be made into various shapes through various molds. The finished elastomer product is light in weight, soft and smooth, provides a soft feel, and can be used repeatedly. The finished elastomer product has good playability and fun. When the elastomer falls on the ground and is broken, the elastomer has a good dispersion effect on the ground due to good elasticity, and is very aesthetic.

In an optional embodiment, SEBS and the oily expandable polystyrene are granular or powdery. Thus, the use is more convenient and various shapes are realized.

In an optional embodiment, the finished product is subjected to ASTM, EN71, USP61, USP62 and USP51 bacterial culture tests; if the product is sterile, the finished product is qualified and is vacuum-packed; and if the product has bacteria, the finished product is unqualified and is subjected to the high temperature sterilization again, thereby ensuring that the product is environmentally-friendly and sterile and is more suitable for children to play.

It should be understood that the above specific embodiments of the present invention are used only for exemplarily illustrating or explaining the principles of the present invention and do not constitute a limitation to the present invention. Therefore, any modification, equivalent substitution and improvement made without departing from the spirit and the scope of the present invention shall be included within the protection scope of the present invention. In addition, the attached claims of the present invention are intended to cover all variations and modification examples that fall within the scope and boundary of the attached claims or equivalent forms of such scope and boundary.

We claim:

1. A thermoplastic elastomer, comprising the following raw materials by mass ratios: 26-33% of SEBS, 65-72% of white mineral oil, 1.5-2.5% of oily expandable polystyrene and 0.008-0.15% of anti-bacterial agent, and
prepared by the following steps:
S1: acquiring SEBS and the oily expandable polystyrene;
S2: mixing the raw materials evenly to obtain mixture A; and
S3: performing high temperature sterilization treatment on the mixture A to prepare a finished product,
wherein S1 to S3 are processed in an aseptic workshop.

2. The thermoplastic elastomer according to claim 1, wherein the raw materials by the mass ratios comprise: 72% of white mineral oil, 1.5% of oily expandable polystyrene, 0.008% of anti-bacterial agent and the balance of SEBS.

3. The thermoplastic elastomer according to claim 1, wherein the raw materials by the mass ratios comprise: 33% of SEBS, 1.5% of oily expandable polystyrene, 0.008% of anti-bacterial agent and the balance of white mineral oil.

4. The thermoplastic elastomer according to claim 1, wherein the raw materials by the mass ratios comprise: 65% of white mineral oil, 2.5% of oily expandable polystyrene, 0.15% of anti-bacterial agent and the balance of SEBS.

5. The thermoplastic elastomer according to claim 1, wherein the raw materials by the mass ratios comprise: 26% of SEBS, 2.5% of oily expandable polystyrene, 0.15% of anti-bacterial agent and the balance of white mineral oil.

6. The thermoplastic elastomer according to claim 1, wherein the raw materials by the mass ratios comprise: 30% of SEBS, 67.9% of white mineral oil, 2% of oily expandable polystyrene and 0.1% of anti-bacterial agent.

7. The thermoplastic elastomer according to claim 1, wherein SEBS and the oily expandable polystyrene are granular or powdery.

8. The thermoplastic elastomer according to claim 1, wherein the finished product is subjected to ASTM, EN71, USP61, USP62 and USPS1 bacterial culture tests; if the product is sterile, the finished product is qualified and is vacuum-packed; and if the product has bacteria, the finished product is unqualified and is subjected to the high temperature sterilization again.
